(19) United States
(12) Patent Application Publication
(10) Pub. No.: US 2020/0164610 A1
(43) Pub. Date: May 28, 2020

(54) GRIPPING MATERIALS

(71) Applicant: 3M INNOVATIVE PROPERTIES COMPANY, St. Paul, MN (US)

(72) Inventors: Douglas A. Davis, Cottage Grove, MN (US); Paul D. Graham, Woodbury, MN (US); James J. Kobe, Newport, MN (US); Thomas B. Galush, Roseville, MN (US); Graham M. Clarke, Woodbury, MN (US); Thomas E. Pahl, Cottage Grove, MN (US); Charles R. Wald, Oakdale, MN (US); Brian W. Lueck, Houlton, WI (US); John G. Petersen, Center City, MN (US)

(21) Appl. No.: 16/611,349

(22) PCT Filed: May 4, 2018
(86) PCT No.: PCT/US2018/031035

§ 371 Date: Nov. 6, 2019

Related U.S. Application Data
(60) Provisional application No. 62/503,474, filed on May 9, 2017.

(51) Int. Cl. B32B 3/30; B32B 5/06; B32B 27/40; B32B 27/12; B32B 37/24; A41D 19/015

(52) U.S. Cl. CPC B32B 3/30; B32B 5/06; B32B 27/40; B32B 27/12; B32B 2262/062; A41D 19/01558; B32B 2437/02; B32B 2262/0284; B32B 2307/536; B32B 37/24

(57) ABSTRACT

Various embodiments disclosed relate to an article. The article includes a first layer defining a first major surface of the article. The first layer includes a plurality of protrusions extending outwardly from the first major surface. The protrusions comprise an elastic polymer component. The article further includes a second layer opposite the first layer, which at least partially defines a second major surface of the article. The first layer is disposed over a range of about 5% surface area of the second layer to about 99% surface area of the second layer. The first layer and the second layer are in direct contact.

### BACKGROUND

Many articles such as gloves sold in the marketplace are used to grab materials. One problem with some gloves is that the grip can be comprised by the inability of the glove to frictionally engage the material. The difficulties resulting from poor frictional engagement can include low work efficiency or even monetary costs associated with damage caused by dropping the material.

### SUMMARY OF THE DISCLOSURE

According to the present disclosure, an article includes a first layer defining a first major surface of the article. The first layer includes a plurality of protrusions extending outwardly from the first major surface. The protrusions comprise an elastic polymer component. The article further includes a second layer opposite the first layer, which at least partially defines a second major surface of the article. The first layer is disposed over a range of about 5% surface area of the second layer to about 99% surface area of the second layer. The first layer is disposed over a range of about 5% surface area of a first side of the second layer to about 99% surface area of the first side of the first layer and the first layer and the second layer are in direct contact.

The present disclosure further describes an article having a first layer defining a first major surface of the article. The first layer includes a plurality of protrusions extending outwardly from the first major surface. The protrusions include an elastic polymer component. The article further includes a second layer defining a second major surface of the article. The second layer includes a second plurality of protrusions extending outwardly from the second major surface. The protrusions include the elastic polymer component. The first layer is disposed over a range of about 5% surface area of the second layer to about 99% surface area of the second layer. The first layer is disposed over a range of about 5% surface area of a first side of the second layer to about 99% surface area of the first side of the first layer and the first layer and the second layer are in direct contact.

The present discourse further describes a method of making an article. The article includes a first layer defining a first major surface. The first layer includes a plurality of protrusions extending outwardly from the first major surface. The protrusions comprise an elastic polymer component. The article further includes a second layer opposite the first layer, which defines a second major surface of the article. The first layer is disposed over a range of about 5% surface area of the second layer to about 99% surface area of the second layer. The first layer is disposed over a range of about 5% surface area of a first side of the second layer to about 99% surface area of the first side of the first layer and the first layer and the second layer are in direct contact. The method includes forming a first assembly. The first assembly includes a support having a plurality of holes defined on a support major surface. The elastic polymer component at least partially fills at least some of the holes of the support and forms the first layer thereon. The method further includes attaching the second layer to the first assembly.

The present disclosure further includes a glove. The glove includes a textile and a griping layer. The griping layer is attached to the textile through a heat-bond. The gripping layer includes a plurality of protrusions extending outwardly from the gripping layer. The protrusions include an elastic polymer component. The gripping layer is disposed over a range of about 5% surface area of a first side of the textile to about 99% surface area of the first side of the textile and textile and the gripping layer are in direct contact.

The present disclosure further includes a method of using the article. The article includes a first layer defining a first major surface. The first layer includes a plurality of protrusions extending outwardly from the first major surface. The protrusions comprise an elastic polymer component. The article further includes a second layer opposite the first layer, which defines a second major surface of the article. The first layer is disposed over a range of about 5% surface area of the second layer to about 99% surface area of the second layer. The first layer is disposed over a range of about 5% surface area of a first side of the second layer to about 99% surface area of the first side of the first layer and the first layer and the second layer are in direct contact. The method includes moving the article relative to a substrate frictionally engaged with the plurality of protrusions.

According to various embodiments, an advantage of the disclosed article and method is that a need for an adhesive or a stitching process to attach the gripping material to the textile can be decreased or substantially eliminated. According to some examples, the gripping materials can be heat-bonded to a textile without an adhesive. In some examples, heat-bonding can allow for greater flexibility during manufacturing because the heat-bond does not require stitching equipment, which may or may not be available in all facilities. Additionally, according to some examples, heat-bonding does not require handling of a release liner that can accompany a pressure-sensitive adhesive. Additionally, according to some examples, heat-bonding as opposed to using adhesives can contribute to a substantial lack of adhesive bleed through and can also reduce concerns regarding solvent exposure.

Additionally, according to various embodiments, the disclosed manufacturing methods can allow for thinner constructions of the article sheets, which can give various advantages such as cost (less material usage) and performance (greater ease in getting into hard-to-reach areas or better user feel).

### BRIEF DESCRIPTION OF THE FIGURES

The drawings illustrate generally, by way of example, but not by way of limitation, various embodiments discussed in the present document.

FIG. 1 is a sectional view of an article including a textile layer and a gripping layer, in accordance with various embodiments.

FIG. 2 is a perspective view of a glove including a gripping layer, in accordance with various embodiments.

FIG. 3 is a sectional view of an article including opposed gripping layers, in accordance with various embodiments.

FIG. 4 is a sectional view of the glove having gripping layers on internal and external surfaces, in accordance with various embodiments.

FIG. 5 is a schematic diagram of a method of making the article, in accordance with various embodiments.

FIG. 6A is scanning electron microscope image of a front surface of a support film, in accordance with various embodiments.

FIG. 6B is another scanning electron microscope image of the back surface of the support film in accordance with various embodiments.

FIG. 7 is a photograph of a glove liner including a gripping layer, in accordance with various embodiments.

FIG. 8 is a photograph of a glove including a gripping layer, in accordance with various embodiments.

FIG. 9A is a photograph of a first side of a glove having a griping layer, in accordance with various embodiments.

FIG. 9B is a photograph of a second side of the glove of FIG. 9A having a second griping layer disposed thereon, in accordance with various embodiments.

FIG. 10 is a photograph of an article including opposed gripping layers, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 56%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99999% or more, or 100%.

The following sections describe, through illustration and example, particular embodiments of the provided articles. Repeated use of reference characters in the specification and drawings generally represents the same or analogous features or elements within the disclosure. It should be understood that numerous other modifications and embodiments can be devised by those skilled in the art, which fall within the scope and spirit of the principles of the disclosure. The figures may not be drawn to scale.

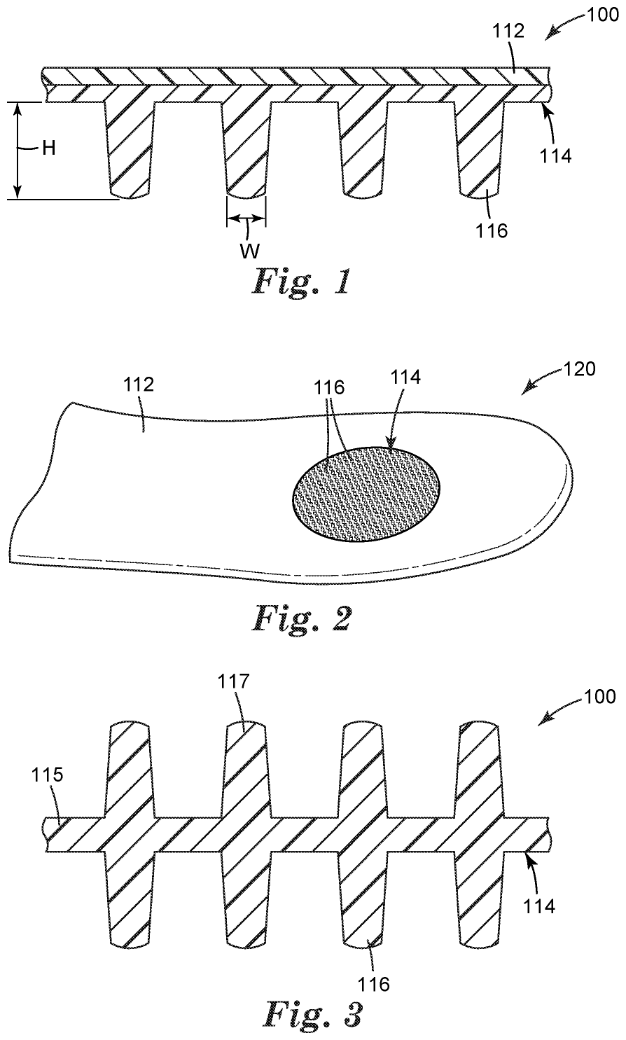

As shown in FIG. 1 article 100 is a multi-component article and includes textile layer 112 and monolithic gripping layer 114, which includes a plurality of protrusions 116 extending outwardly therefrom. Each of protrusions 116 has a composition that is substantially the same as gripping layer 114. In other examples protrusions 116 can have a different composition than gripping layer 114. Each of textile layer 112 and gripping layer 114 at least partially define external major surfaces of article 100. Gripping layer 114 can be in contact with 5% surface area to about 99% surface area of textile layer 112.

Protrusions 116 can be arranged according to either a random or non-random two-dimensional replicated pattern or array. In some examples, the external, exposed surfaces of protrusions 116 include a first polymer component.

Each of protrusions 116 can have a constant or variable cross-sectional shape. For example, as shown in FIG. 1, protrusions 116 are generally cylindrical in shape. Other examples of suitable shapes include truncated cones or pyramids, rectangles, hemispheres, squares, hexagons, octagons, and combinations thereof. As described herein, protrusions 116 can be made by extruding the polymer component in a carrier film having holes therein. Protrusions 116 are ultimately formed in the holes. As a result of being formed in a hole, the sides of protrusions 116 can have a slight taper to facilitate removal from the holes of the carrier film. It is understood, however, that the protrusions 116 can assume any of a number of non-cylindrical shapes, including truncated cones or pyramids, rectangles, hemispheres, squares, hexagons, octagons, and combinations thereof.

Protrusions 116 can have a configuration that facilitates some degree of deflection, or buckling, when compressive force is applied to gripping layer 114. Optionally and as shown, protrusions 116 have a certain height “H” and a certain width “W” (both shown in FIG. 1), where each is fairly uniform (or monodispersed) about an average respective value. Having a distribution of heights and widths, however, can also provide an acceptable gripping surface.

The height of protrusions 116 need not be particularly restricted, but a suitable example of article 100 uses protrusions 116 having an average height “H” of about 10 micrometers to about 1500 micrometers, about 25 micrometers to about 700 micrometers, about 75 micrometers to about 600 micrometers, less than, equal to, or greater than about 10 micrometers, 25, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 900, 925, 950, 975, 1000, 1025, 1050, 1075, 2000, 2025, 2050, 2075, 3000, 3025, 3050, 3075, 4000, 4025, 4050, 4075, or 5000 micrometers.

The number average height-to-width aspect ratio (“H/W”) of protrusions 116 can range from about 0.5 to about 10, about 0.75 to about 7, about 1 to about 5 less than, equal to, or greater than about 0.5, 0.75, 1.0, 1.1, 1.2, 1.25, 2, 2.5, 3, 3.5, 4, 4.5, 5, 5.5, 6, 6.5, 7, 7.5, 8, 8.5, 9, 9.5, or 10. The number density of protrusions 116 can depend in part on their size, and can also vary based on the desired texture of gripping layer 114. In some examples, protrusions 116 have an area number density ranging from about 15 per square centimeter to about 3000 per square centimeter, about 50 per square centimeter to about 1250 per square centimeter, about 100 per square centimeter to about 1000 per square centimeter, about 150 per square centimeter to about 800 per square centimeter, about 250 per square centimeter to about 600 per square centimeter, less than about, equal to about, or greater than about 50 per square centimeter, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, or 3000 per square centimeter.

As mentioned, some or all of gripping layer 114 can include a polymer component. The polymer component can include one or more polymers. The one or more polymers can range from about 50 wt % to about 100 wt % the polymer component, about 60 wt % to about 90 wt %, about 70 wt % to about 80 wt %, less than, equal to, or greater than 50 wt %, 55, 60, 65, 70, 75, 80, 85, 90, 95, or 100 wt %. At least one of the polymers can be an elastomer. The term “elastomer” reflects a property of the material that it can undergo a substantial elongation and then return to its original dimensions upon release of the stress elongating the elastomer. In some cases an elastomer is able to undergo at least 10% elongation (at a thickness of 0.5 mm), and return to at least 50% recovery after being held at that elongation for 2 seconds and after being allowed 1 minute relaxation time. In some examples, an elastomer can undergo 25% elongation without exceeding its elastic limit. In some examples elastomers can undergo elongation to as much as 300% or more of their original dimensions without tearing or exceeding the elastic limit of the composition. Elastomers can be defined to reflect this elasticity as in ASTM Designation D883-96 as a macromolecular material that at room temperature returns rapidly to approximately its initial dimensions and shape after substantial deformation by a weak stress and release of the stress. ASTM Designation D883-96 as a macromolecular material that, at room temperature, returns rapidly to approximately its initial dimensions and shape after substantial deformation by a weak stress and release of the stress. ASTM Designation D412-98 A can be an appropriate procedure for testing rubber properties in tension to evaluate elastomeric properties.

For some applications, thermoset elastomers may be used. Generally, such compositions include relatively high molecular weight compounds which, upon curing, form an integrated network or structure. The curing may be by a variety of methods, including chemical curing: agents, catalysts, and/or irradiation. The final physical properties of the material are a function of a variety of factors, including the number and weight average polymer molecular weights, the melting or softening point of the reinforcing domains of the elastomer, if any (which, for example, can be determined according to ASTM Designation D 1238-86), the percent by weight of the elastomer composition which comprises hard segment domains, the structure of the toughening or soft segment (low glass transition temperatures) portion of the elastomer composition, the crosslink density, and the nature and levels of additives or adjuvants.

Suitable classes of elastomers include anionic triblock copolymers, polyolefin-based thermoplastic elastomers, thermoplastic elastomers based on halogen-containing polyolefins, thermoplastic elastomers based on dynamically vulcanized elastomer-thermoplastic blends, thermoplastic polyether ester or polyester based elastomers, thermoplastic elastomers based on polyamides or polyimides, ionomeric thermoplastic elastomers, hydrogenated block copolymers in thermoplastic elastomer interpenetrating polymer networks, thermoplastic elastomers by carbocationic polymerization, polymer blends containing styrene/hydrogenated butadiene block copolymers, and polyacrylate-based thermoplastic elastomers. Some specific examples of elastomers are natural rubber, butyl rubber, EPDM rubber, silicone rubber such as polydimethyl siloxane, polyisoprene, polybutadiene, polyurethane, ethylene/propylene/diene terpolymer elastomers, chloroprene rubber, styrene-butadiene copolymers (random or block), styrene-isoprene copolymers (random or block), styrene-ethylene-butylene copolymers (random or block), acrylonitrile-butadiene copolymers, mixtures thereof and copolymers thereof. The block copolymers can be linear, radial or star configurations and may be diblock (AB) or triblock (ABA) copolymers mixtures thereof. Blends of these elastomers with each other or with modifying non-elastomers are also contemplated. Commercially available elastomers include block polymers (e.g., polystyrene materials with elastomeric segments), available from Shell Chemical Company of Houston, Tex., under the designation KRATON™. The hardness of the polymer used in protrusions 116 can be characterized by its Shore durometer. For example, the polymer can have a Shore A hardness ranging from about 5 to about 100, about 20 to about 40, less than, equal to, or greater than about 5, 10, 15, 20, 25, 30, 35, 40, 45, 50, 55, 60, 65, 70, 75, 80, 85, 90, 95, or 100. A Shore D hardness of the polymer can range from about 1 to about 70, about 60 to about 80, less than, equal to, or greater than about 1, 5, 10, 15, 20, 25, 30, 35, 40, 45, 50, 55, 60, 65, or 70.

Article 100 can be configured to be free of intermediate layers such as a base layer. Article 100 can also be configured to be free of other support layers between textile layer 112 and gripping layer 114. For example, article 100 can be free of an intermediate support layer such as a scrim layer or an adhesive layer. A scrim layer can be generally understood to be an intermediate layer that gripping layer 114 and textile layer 112 are joined to. A scrim layer can be formed of many materials, including a woven or non-woven material. In some examples of article 100, which are free of the scrim layer, gripping layer 114 and textile layer 112 are in direct contact with each other.

Textile layer 112 can include a textile material. The textile material can range from about 50 wt % to about 100 wt % textile layer 112, about 60 wt % to about 90 wt %, about 70 wt % to about 80 wt %, less than, equal to, or greater than 50 wt %, 55, 60, 65, 70, 75, 80, 85, 90, 95, or 100 wt %.

The textile of textile layer 112 can be any suitable textile. Examples of suitable textiles include a spun-bound non-woven textile, a melt-blown non-woven textile, a needle entangled non-woven textile, a braided textile, a knit textile or a water-entangled non-woven textile. The textile can include any suitable material. Examples of suitable materials include a polyester, an aramid fiber, an acrylic, a nylon fiber, a polyurethane, an olefin, a carbon fiber, a metallic fiber, a polyactide fiber, cotton, or a combination thereof.

The textile can be incorporated into a garment. In some examples, the textile can range from about 50 wt % to about 100 wt % the garment, about 60 wt % to about 90 wt %, about 70 wt % to about 80 wt %, less than, equal to, or greater than 50 wt %, 55, 60, 65, 70, 75, 80, 85, 90, 95, or 100 wt %. While not so limited, the garment can be a sock, pants, a glove, a wristband, a headband, a hat, or a shirt. As an example, FIG. 2 is a perspective view of glove 120. Glove 120 includes textile layer 112 and griping layer 114. As shown, gripping layer 114 and textile layer 112 are directly joined to each other. Protrusions 116 extend outwardly from gripping layer 114. As shown in FIG. 2, the gripping layer 114 extends over less than 100% surface area of one side of textile layer 112. Textile layer 112 can extend over 5% surface area to about 99% surface area of gripping layer 114, about 20% surface area to about 80% surface area, less than, equal to, or greater than 5% surface area, 10, 15, 20, 25, 30, 35, 40, 45, 50, 55, 60, 65, 70, 75, 80, 85, 90, 95, or 99% surface area. In alternative examples gripping layer 114, can completely envelop textile layer 112.

In other examples of article 100, textile layer 112 is replaced with second gripping layer 115, as shown in FIG. 3. Second gripping layer 115 can be substantially similar to gripping layer 114. For example, second gripping layer 115 includes protrusions 117 extending therefrom. Gripping layers 114 and 115, as well as protrusions 116 and 117 can include the same elastic polymeric materials. Griping layers 114 and 115 can be joined to each other through hot pressing.

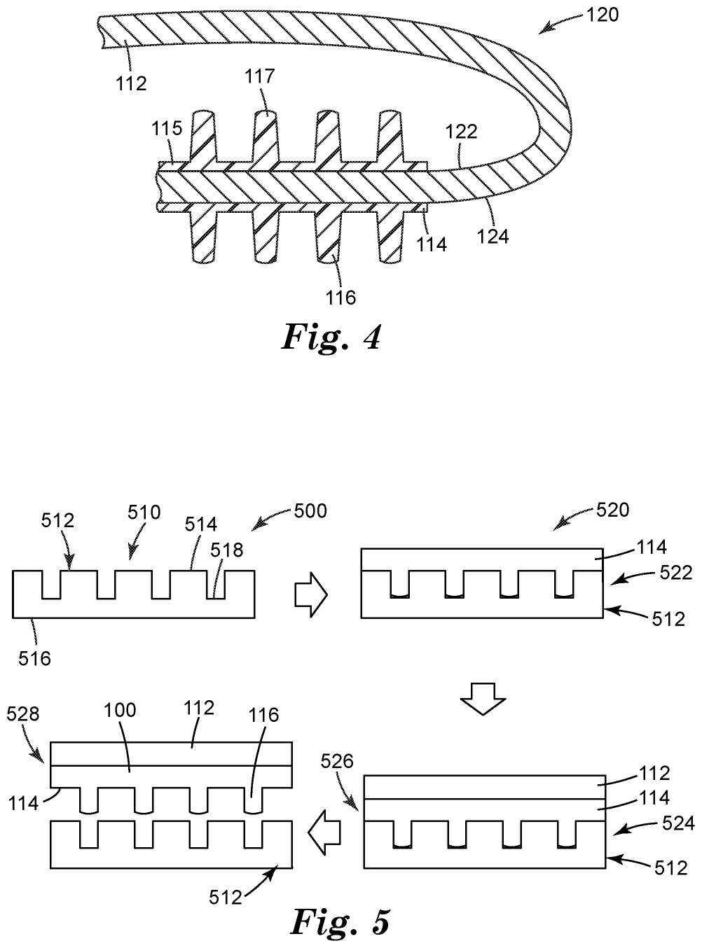

In other examples of glove 120, second griping layer 115 can be located on interior surface 122 of glove 120 and gripping layer 114 can be located on external surface 124 of glove 120. An example is shown in FIG. 4, which is a sectional view of glove 120 having gripping layers on internal and external surfaces. As configured, a user's hand would contact the gripping layer 115 that is on the inside, and an object would contact the gripping layer 114 on the outside. This configuration can add to both the utility and the comfort of glove 120, for example by reducing the tendency of the hand to slip on interior surface 122 of glove 120.

Article 100 can be formed through many suitable methods. An example of a suitable method is shown in FIG. 5, which is a schematic depiction of a method of forming article 100. As shown in FIG. 5, method 500 includes multiple operations. Operation 510 includes providing a support such as support film 512. Although shown as a film, support film 512 can be a continuous belt or other suitable support structure.

Support film 512 can be formed in many suitable ways. For example, support film 512 can be formed by feeding a molten stream of a support polymeric material from an extrusion die to a nip point located between a pressure roller and a forming roller. The support polymeric material can include one or more polymers. Non-limiting examples of suitable polymers include a polypropylene, a polycarbonate, a polyurethane, polyethylene, polyamide, polyester, polyester terephthalate, glycol-modified polyethylene terephthalate, copolymers thereof, or mixtures thereof. The one or more polymers can range from about 50 wt % to about 100 wt % of the support polymeric material, about 60 wt % to about 90 wt %, about 70 wt % to about 80 wt %, less than, equal to, or greater than 50 wt, 55, 60, 65, 70, 75, 80, 85, 90, 95, or 100 wt %.

In some examples, a forming roller can include a plurality of posts. Both the pressure roller and the forming roller can be adapted to be maintained at a temperature below a solidification temperature of the support polymeric material. As non-limiting examples, the solidification temperature can be a glass transition temperature, a crystallization temperature, or a gelation temperature of the support polymeric material. This can help to solidify the polymeric material. As the polymeric material solidifies, holes are formed around the posts. At substantially the same time, the pressure roller presses the polymeric material down in order to compress the polymeric material into a film. After passing through the nip point, the polymeric material comes off the forming roller as support film 512. Additionally, maintaining rollers below the solidification temperature can help to non-destructively remove support film 512 from the rollers such that substantially zero or at least a minimal amount of material is left on either of the rollers.

Support film 512 has extrusion surface 514 and back surface 516. Extrusion surface 514 defines a major surface and includes a plurality of holes 518. In some examples of support film 512, holes 518 can span between extrusion surface 514 and back surface 516. In some examples, holes 518 are closed at an intermediate layer, which is located proximate to back surface 516. In some circumstances it can be desirable to open the intermediate layer such that the hole extends fully between surfaces 516 and 514.

There are many suitable post-processing methods to open the intermediate layer. An example of such a way can include flame treating back surface 516. In flame treating back surface 516, the temperature of the polymeric material is raised above its solidification temperature. This in turn can allow the support polymeric material to flow and open the end of the hole thereby creating a through hole in support film 512. Opening the intermediate layer can form a vent in support film 512 such that air can escape from holes 518 during extrusion of gripping layer 114.

Method 500 further includes operation 520. Operation 520 includes forming first assembly 522. To form first assembly 522, the gripping layer polymeric material is dispensed to extrusion surface 514 of support film 512 to form gripping layer 114.

As non-limiting examples, the gripping layer polymeric material can be extrusion coated onto support film 512 such that the gripping layer polymeric material at least partially fills holes 518 of support film 512. Support film 512 can be fed directly into an extruder from, for example, a forming roller or a film unwind. Alternatively, support film 512 can be cut into segments and those segments, in turn, can be fed into the extruder.

There are additional suitable operations that can be used to form support film 512. For example, a sheet including the support polymeric material can be provided and the holes can be directly formed thereon. The holes can be formed for example, through mechanical punching or laser drilling.

The combination of the solidification temperature, latent heat of melting and thermal conductivity of support film 512 allows it to remain intact while gripping layer 114 is coated onto it. Additionally, extrusion can be performed at a temperature above a solidification temperature (e.g., a glass transition temperature, crystallization temperature, or gelation temperature) of the gripping layer polymer component but below a solidificaiton temperature of the support film polymeric material. This can help to allow the gripping layer polymeric material to flow into holes 518 while the structure of support film 512 remains intact. It should be noted that while extrusion is discussed herein, other techniques such as hot pressing can also be used in conjunction with operation 520.

Although extrusion is described to form gripping layer 114 other techniques are within the scope of this disclosure. For example, a solution of the materials (e.g., gripping layer polymer component) can be applied to support film 512 and dried or cured thereon. In some examples, curing can include heating or exposure to radiation (e.g., light). In other examples, at least one of a solution of monomers, oligomers, polymers, and initiators (e.g., photoinitiators or thermoinitiators) can be applied to the support film 512 and the solution can be cured thereon.

Method 500 further includes operation 524 in which textile layer 112 is attached to gripping layer 114. This forms second assembly 526. Textile layer 112 can be attached to gripping layer 114 through a hot-pressing, where the textile layer 112 and the gripping layer 114 are heated and sufficient pressure is applied to the layers for a suitable amount of time to form a bond between the layers. In examples, where article 100, includes first griping layer 114 and second gripping layer 115 two first assemblies 522 can be contacted and heat and pressure can be applied to attach gripping layer 114 and second gripping layer 115.

First assembly 522 can be cooled prior to attachment between textile layer 112 and gripping layer 114. Alternatively, textile layer 112 can be directly attached to gripping layer 114 and then second assembly 526 can be cooled. In order to allow the gripping layer polymeric material to set properly, first assembly 522 can be adapted to cool for any suitable set time. Examples of suitable set times can range from about 30 minutes to about one month or about 5 hours to about 2 weeks. The set time can range for even longer period of time such as greater than 1 month or greater than 1 year. Adequate cooling of gripping layer 114 allows protrusions 116 to properly form.

Method 500 can further include operation 528, in which support film 512 is removed from gripping layer 114 to yield article 100. It can be desirable to remove griping layer 114 from support film 512 in a substantially non-destructive manner such that a minimal amount, if any, of support film 512 and griping layer 114 remain attached after operation 528. Substantial prevention of this can be accomplished by selecting materials in support film 512 and gripping layer 114, respectively, that are individually strong and have low chemical adhesion with each other. By chemical adhesion it is meant that the materials are less likely to form a bond or otherwise interact with each other. Further prevention of destructive removal can be accomplished by smoothing the surface of holes 518 or by allowing gripping layer 114 to set for an appropriate amount of time. Also, a coating may be applied to the extrusion surface of support film 512 that is selected in order to reduce the adhesion to gripping layer 114. Following removal, support film 512 can be reused to form additional article 100.

Article 100 can be used in many different ways. For example, if article 100 is a glove, a user can wear the glove and use it to grip a substrate. For example, protrusions 116 of gripping layer 114 can be frictionally engaged with a substrate. This can help to enhance the grip between article 100 and the substrate. In some examples, the substrate can also include a plurality or protrusions extending therefrom. If the substrate also includes the protrusions, then protrusions 116 can be frictionally engaged with the protrusions of the substrate thereby increasing the grip between article 100 and the substrate.

### EXAMPLES

Various embodiments of the present disclosure can be better understood by reference to the following Examples, which are offered by way of illustration. The present disclosure is not limited to the Examples given herein.

The following abbreviations are used to describe the examples:
° C.: degrees Centigrade
OF: degrees Fahrenheit
cm: centimeter
g/m²: grams per square meter
m/min: meters per minute
mil: 10⁻³ inch
mm: millimeter
μm: micrometer
rpm: revolutions per minute

Unless stated otherwise, all reagents were obtained or are available from chemical vendors such as Sigma-Aldrich Company, St. Louis, Mo., or may be synthesized by known methods. Unless otherwise reported, all ratios and percentages are by weight.

Abbreviations for materials and reagents used in the examples are as follows:
PPR: A polypropylene resin, obtained under the trade designation DOW C700-35N 35 MFI from Dow Chemical Company, Midland, Mich.
PU: A polyurethane resin, obtained under the trade designation ESTAGRIP ST80A from Lubrizol Corporation, Wickliffe, Ohio.

### Preparation of Support Film

A polypropylene film was made by extruding PPR through a 6.35 cm single screw extruder to a 30.5″ wide single layer die (obtained under the trade designation EDI from Nordson Extrusion Dies Industries LLC, Chippewa Falls, Wis.). The extrusion heating zone temperatures were as follows: Zone 1 was 190° C., Zone 2 was 204° C., Zones 3, 4, end cap, necktube and die were all 218° C. The extruder speed was 25 rpm.

The two rolls comprising the nip were water cooled rolls with a nominal 30.5 cm in diameter and 40.6 cm face widths. Nip force was provided by pneumatic cylinders. The smooth steel backup roll had a temperature set point of 18° C. The tooling roll had male post features cut into the surface of the roll. The male post features were chrome plated. The male features (defined as posts) on the tool surface were flat square topped pyramids with a square base, on top of which was a sharp pointed pyramid. The top of the posts were 76 μm square and the bases were 237 μm square on each side. The base of the sharp pointed pyramid was 76 μm on each side and the height of the sharp pointed pyramid on top was 51 μm. The overall post height was 508 μm. The center-to-center spacing of the posts was 820 μm in both the radial and cross roll directions. The tooling roll had a temperature set point of 65° C. The tooling roll and backup rolls were directly driven. The nip force between the two nip rolls was 109 Newtons per linear centimeter. The extrudate takeaway line speed was 9.14 m/min.

The polymer was extruded from the die directly into the nip between the tooling and backup roll. The male features on the tooling roll created indentations in the extrudate. A thin layer of polymer remained between the tooling and backup roll. Typically this layer was less than 20 μm thick. The extrudate remained on the tooling roll for 180 degrees of wrap to chill and solidify the extrudate into a polymeric film. The posts in the tool created cavities in the film that were about 350-μm (14 mils) deep. The average base thickness (the thickness in the area free of cavities) of the polypropylene film was also about 350-μm (14 mils).

The polymeric film containing indentations was then converted into a perforated film using the following procedure. A flame perforation system as described in U.S. Pat. No. 7,037,100 (Strobel et. al.), the disclosure of which is incorporated herein by reference, and utilizing the burner design from U.S. Pat. No. 7,635,264 (Strobel et. al.), the disclosure of which is incorporated herein by reference, was used to remove the thin layer at the bottom of the indentations.

Specific modifications to the equipment and process conditions for this experiment were as follows:

The chill roll was a smooth surface roll without an etched or engraved pattern.

The burner was a 30.5 centimeter (12 inch) six port burner, anti-howling design as described in U.S. Pat. No. 7,635,264 (Strobel et. al.), the disclosure of which is incorporated by reference, and was obtained from Flynn Burner Corporation, New Rochelle, N.Y.

Unwind Tension: 66 Newton total tension

Winder Tension: 44 Newton total tension

Burner BTU's: 8065 BTU/cm/hour

1% excess oxygen

Gap between burner and the film surface: 4.45 mm

Line Speed: 30 m/min.

Chill roll cooling water set point: 15.5° C.

The polymeric film was processed at the above conditions. The web orientation was such that the side of the film with the thin polymer layer was closest to the burner and opposite of the chill roll. The chill roll cooled the main body of the film, keeping the majority of the film below the softening point of the polymer. Heat from the burner flame caused the remaining thin polymer layer to melt thereby creating the perforations in the film.

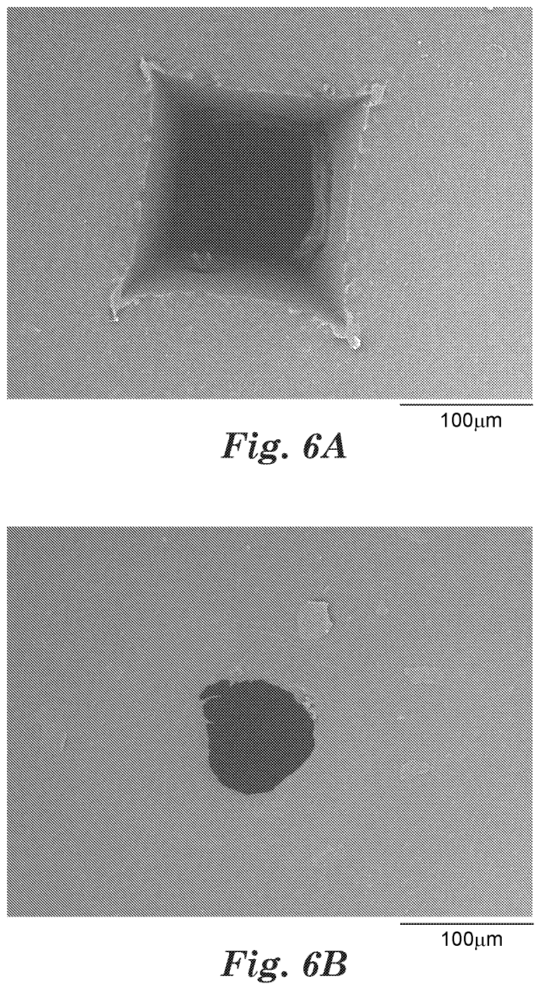

An exemplary scanning electron microscope image of the cavities on the first major surface of the support film and exemplary image of the holes on the back surface after flame are shown in FIG. 6A and FIG. 6B, respectively.

### Example 1

PU was extruded through a twin screw extruder that was connected to both a gear pump and a single layer drop die. The extrusion temperatures were as follows: Zone 1 was 179° C., Zone 2 was 192° C., Zones 3 was 193° C., and Zone 4 was 194° C., necktube was 204° C. and die was at 193° C. The extruder speed was 100 rpm. The extrudate was contacted with the support film in a nip comprising two one roll that was steel and one rubber covered nip roll. Nip force was provided by pneumatic cylinders. The backup roll had a temperature set point of 27° C. The extrudate takeaway line speed was 1.27 m/min (4.16 feet per minute).

PU was extrusion cast as a thermoplastic polyurethane film onto the Support Film using the twin-screw extruder as described above. Optical microscopy analysis showed that PU essentially filled the cavities in the Support Film and there was a roughly 100-μm thick base layer (the film connecting the posts) and the posts were about 380-μm tall.

A piece of the resulting PU-support film combination was die cut into a circular section with 0.75 inch (1.91 cm) diameter, and the PU surface was contacted with the fingertip portion of a synthetic fabric glove liner. This construction was placed into a platen press that was operating at temperatures of 290° F. (143.3° C., top platen) and 264° F. (128.9° C. bottom platen), and an applied load of 4.000 pounds was applied for 60 seconds. The construction was removed from the press, and the support film was removed to expose the posts that had formed, as shown in FIG. 7. An attempt was made to remove the PU layer from the surface of the glove liner, but the PU layer was well-attached to the glove liner.

### Example 2

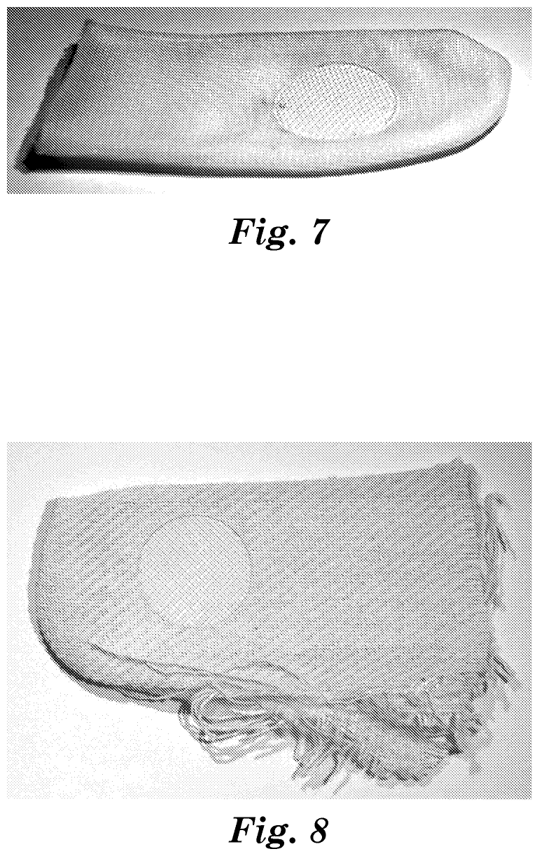

The procedure generally described in Example 1 was repeated, with the exception that a work glove with polyethylene terephthalate/cotton (65%/35%) fabric was substituted for the synthetic fabric glove liner. The resulting glove is shown in FIG. 8.

### Example 3

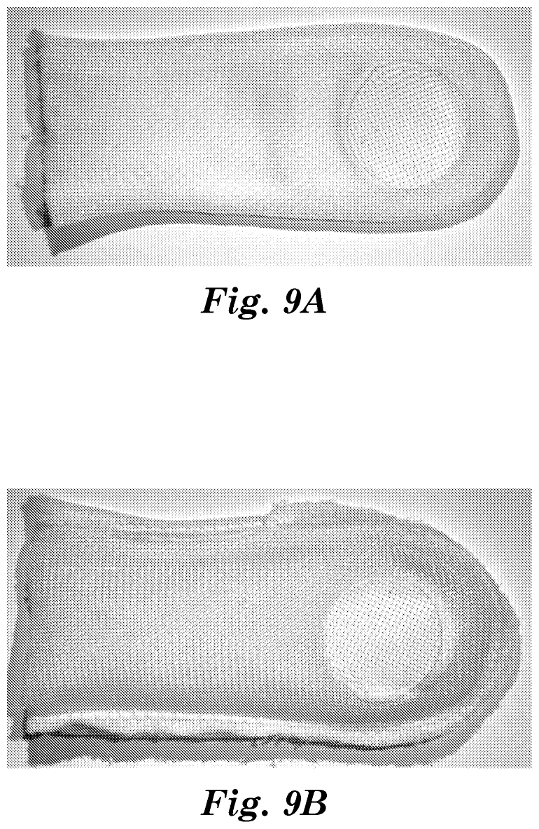

The procedure generally described in Example 1 was repeated, with the exception that two circular sections of the PU-support film combination were placed onto both sides of the fingertip region of the synthetic fabric work glove (one circular section onto each side of the glove). Each side of the resulting glove is shown in FIG. 9A and FIG. 9B.

### Example 4

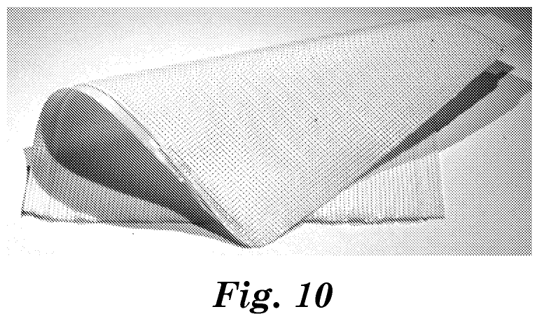

The procedure of making PU-support film combination generally described in Example 1 was repeated. Instead of placing the PU-support film combination on a glove, two pieces of the PU-Support Film combination were contacted with each other such that the two PU surfaces were in contact. This construction was placed into a platen press that was operating at temperatures of 290° F. (143.3° C., top platen) and 264° F. (128.9° C., bottom platen), and an applied load of 4,000 pounds was applied for 60 seconds. The construction was removed from the press, and the pieces of the Support Film were removed from both sides to generate a PU film with posts on both sides, as shown in FIG. 10.

### ADDITIONAL EMBODIMENTS

The following exemplary embodiments are provided, the numbering of which is not to be construed as designating levels of importance:

Embodiment 1 provides an article comprising:

a first layer defining a first major surface of the article, the first layer comprising a plurality of protrusions extending outwardly from the first major surface, wherein the protrusions comprise an elastic polymer component; and

a second layer opposite the first layer and partially defining a second major surface of the article:

wherein the first layer is disposed over a range of about 5% surface area of a first side of the second layer to about 99% surface area of the first side of the first layer and the first layer and the second layer are in direct contact.

Embodiment 2 provides an article comprising:

a first layer defining a first major surface of the article, the first layer comprising a plurality of protrusions extending outwardly from the first major surface, wherein the protrusions comprise an elastic polymer component; and

a second layer opposite the first layer and defining a second major surface of the article, the second layer comprising a second plurality of protrusions extending outwardly from the second major surface, wherein the protrusions comprise the elastic polymer component;

wherein the first layer and the second layer are in direct contact.

Embodiment 3 provides the article of any one of Embodiments 1 or 2, wherein the elastic polymer component has at least one of a Shore A hardness ranging from about 5 to about 100 and a Shore D hardness ranging from about 1 to about 70.

Embodiment 4 provides the article of any one of Embodiments 1-3, wherein the elastic polymer component ranges from about 50 wt % to about 100 wt %, of the individual protrusions.

Embodiment 5 provides the article of any one of Embodiments 1-4, wherein the protrusions are arranged in a replicated two-dimensional pattern on the first layer.

Embodiment 6 provides the article of any one of Embodiments 1-5, wherein the protrusions have a height-to-width aspect ratio ranging from about 0.5 to about 10.

Embodiment 7 provides the article of any one of Embodiments 1-5, wherein the protrusions have a height-to-width aspect ratio ranging from about 1 to about 6.

Embodiment 8 provides the article of any one of Embodiments 1-5, wherein the protrusions have a height-to-width aspect ratio ranging from about 1.25 to about 6.

Embodiment 9 provides the article of any one of Embodiments 1-8, wherein the protrusions have a height ranging from about 10 micrometers to about 1500 micrometers.

Embodiment 10 provides the article of any one of Embodiments 1-8, wherein the protrusions have a height ranging from about 50 micrometers to about 600 micrometers.

Embodiment 11 provides the article of any one of Embodiments 1-8, wherein the protrusions have a height ranging from about 100 micrometers to about 800 micrometers.

Embodiment 12 provides the article of any one of Embodiments 1-11, wherein the protrusions have an area number density on the first layer ranging from about 15 per square centimeter to about 3000 per square centimeter.

Embodiment 13 provides the article of any one of Embodiments 1-12, wherein the protrusions have an area number density ranging from about 100 per square centimeter to about 1000 per square centimeter.

Embodiment 14 provides the article of any one of Embodiments 1-13, wherein the protrusions have a constant cross-sectional shape.

Embodiment 15 provides the article of any one of Embodiments 1-13, wherein the protrusions have a variable cross-sectional shape.

Embodiment 16 provides the article of any one of Embodiments 1-14, wherein the elastic polymer component is one or more polymers.

Embodiment 17 provides the article of Embodiment 16, wherein the one or more polymers is an elastomer chosen from a polyurethane, a styrene-ethylene-butylene-styrene block copolymer, a styrene-isoprene-styrene block copolymer, or mixtures thereof.

Embodiment 18 provides the article of any one of Embodiments 1-17, wherein griping layer is monolithic.

Embodiment 19 provides the article of any one of Embodiments 1-18, wherein the article is free of an intermediate support layer between the first layer and the second layer

Embodiment 20 provides the article of Embodiment 19, wherein the first layer and the second layer are joined through a heat-bond.

Embodiment 21 provides the article of any one of Embodiments 1 or 3-20, wherein the second layer comprises a textile.

Embodiment 22 provides the article of Embodiment 21, wherein the textile ranges from about 50 wt % to about 100 wt % the second layer.

Embodiment 23 provides the article of any one of Embodiments 21 or 22, wherein the textile ranges from about 80 wt % to about 100 wt % the second layer.

Embodiment 24 provides the article of any one of Embodiments 21-23, wherein the textile is a spun-bound non-woven textile, a melt-blown non-woven textile, a needle entangled non-woven textile, a braided textile, a knit textile, a water-entangled non-woven textile, or a combination thereof.

Embodiment 25 provides the article of any one of Embodiments 21-24, wherein the textile is a woven textile, a non-woven textile, or a combination thereof.

Embodiment 26 provides the article of Embodiment 24, wherein the textile is a knit textile.

Embodiment 27 provides the article of any one of Embodiments 21-26 wherein the textile is incorporated into a garment.

Embodiment 28 provides the article of Embodiment 27, wherein the garment is chosen from a sock, pants, a glove, a wristband, a headband, a hat, or a shirt.

Embodiment 29 provides the article of any one of Embodiments 1 or 3-20, wherein the second layer comprises:

a second plurality of protrusions extending outwardly from the second layer, wherein the second plurality of protrusions comprise the elastic polymer component of the first plurality of protrusions.

Embodiment 30 provides a method of making the article of any one of Embodiments 1-29, the method comprising:

forming a first assembly, the first assembly comprising a support having a plurality of holes defined on a support major surface, the elastic polymer component at least partially filling at least some of the holes of the support and forming the first layer thereon; and attaching the second layer to the elastic polymer of the first assembly.

Embodiment 31 provides the method of Embodiment 30, wherein the support is stiffer than the elastic polymer component.

Embodiment 32 provides the method of Embodiment 30, wherein at least one of a Shore D hardness and a Shore A hardness of the support is greater than the Shore D hardness and a Shore A hardness of the first polymer component.

Embodiment 33 provides the method of any one of Embodiments 30-32, wherein the support comprises a support polymer component.

Embodiment 34 provides the method of Embodiment 33, wherein the support polymer component comprises one or more polymers.

Embodiment 35 provides the method of Embodiment 34, wherein the one or more polymers are chosen from a polypropylene, a polycarbonate, a polyurethane, polyethylene, polyamide, polyester, polyester terephthalate, glycol-modified polyethylene terephthalate, copolymers thereof, or mixtures thereof.

Embodiment 36 provides the method of any one of Embodiments 30-35, wherein forming the first assembly includes extrusion or hot-pressing.

Embodiment 37 provides the method of Embodiment 36, wherein extrusion is performed at an extrusion temperature above a solidification temperature of the first polymer component but below a solidification temperature of the support.

Embodiment 38 provides the method of Embodiment 37, further comprising heating the support to a temperature below the solidification temperature.

Embodiment 39 provides the method of any one of Embodiments 30-38, wherein attaching the second layer to the first assembly comprises at least one of hot-pressing the second layer to the first layer, adhering the second layer to the first layer, and sewing the second layer to the first layer.

Embodiment 40 provides the method of any one of Embodiments 30-39, further comprising removing the support to expose the plurality of protrusions.

Embodiment 41 provides the method of any one of Embodiments 30-40, further comprising forming the support.

Embodiment 42 provides the method of Embodiment 41, wherein forming the support comprises:

dispensing the support polymer component on a tool having a plurality of posts to form a plurality of holes in the support polymer component to form a support film precursor.

Embodiment 43 provides the method of Embodiment 42, further comprising flame treating one side of the support precursor to open one end of each of the plurality of holes.

Embodiment 44 provides the method according to any one of Embodiments 30-43, further comprising forming the second layer.

Embodiment 45 provides the method according to Embodiment 44, wherein forming the second layer comprises:

forming a second assembly, the second assembly comprising a second support having a plurality of holes defined on a support film major surface, the elastic polymer component at least partially filling at least one of the holes of the support film and applying heat and pressure to bond the second layer to the first layer.

Embodiment 46 provides a glove comprising:

a textile; and

a griping layer attached to the textile through a heat-bond, the gripping layer comprising a plurality of protrusions extending outwardly from the gripping layer, wherein the protrusions comprise an elastic polymer component;

wherein the glove is free of an intermediate support layer between the gripping layer and textile.

Embodiment 47 provides a method of using the article of any one of Embodiments 1-29, the article formed by the method of any one of Embodiments 20-45, or the glove of Embodiment 46, the method comprising:

moving the article relative to a substrate frictionally engaged with the plurality of protrusions.

Embodiment 48 provides the method of Embodiment 47, wherein the working surface comprises a third plurality of protrusions extending outwardly from the substrate.

Embodiment 49 provides the method of Embodiment 48, wherein the plurality of protrusions of the article or glove are frictionally engaged with the plurality of protrusions of the substrate.

Embodiment 50 provides the method of any one of Embodiments 46-49, further comprising:

rubbing the plurality of protrusions against the substrate to dislodge and collect sanding swarf or debris on the substrate.

Embodiment 51 provides an article comprising:

a support having a plurality of holes defined on a support major surface: and

an elastic polymer component at least partially filling at least some of the holes of the support and forming the first elastic layer thereon.

Embodiment 52 provides the article of Embodiment 51, wherein the elastic polymer component ranges from a Shore A hardness of about 5 to a Shore D hardness of about 70.

Embodiment 53 provides the article of any one of Embodiments 51 or 52, wherein the elastic polymer component comprises one or more polymers.

Embodiment 54 provides the article of Embodiment 53, wherein the one or more polymers is an elastomer chosen from a polyurethane, a styrene-ethylene-butylene-styrene block copolymer, a styrene-isoprene-styrene block copolymer, or mixtures thereof.

Embodiment 55 provides the method of any one of Embodiments 51-54, wherein the support comprises a support polymer component.

Embodiment 56 provides the method of Embodiment 55, wherein the support polymer component comprises one or more polymers.

Embodiment 57 provides the method of Embodiment 56, wherein the one or more polymers are chosen from a polypropylene, a polycarbonate, a polyurethane, polyethylene, polyamide, polyester, polyester terephthalate, glycol-modified polyethylene terephthalate, copolymers thereof, or mixtures thereof.

1-15. (canceled)

16. The method of claim 21, wherein the elastic polymer component comprises one or more polymers chosen from a polyurethane, a styrene-ethylene-butylene-styrene block copolymer, a styrene-isoprene-styrene block copolymer, or mixtures thereof.

17. The method of claim 21, wherein the elastic polymer component comprises one or more polymers chosen from a polypropylene, a polycarbonate, a polyurethane, polyethylene, polyamide, polyester, polyester terephthalate, glycol-modified polyethylene terephthalate, copolymers thereof, or mixtures thereof.

18. The method of claim 21, wherein forming the first assembly includes extrusion or hot-pressing.

19. The method of claim 21, wherein attaching the second layer to the first layer of the first assembly comprises at least one of hot-pressing the second layer to the first layer, adhering the second layer to the first layer, and sewing the second layer to the first layer.

20. The method of claim 21, further comprising removing the support film to expose the plurality of protrusions.

21. A method of making an article, the method comprising:
forming a first assembly, the first assembly comprising
a support film having an extrusion surface and a back surface opposite the extrusion surface, and a plurality of holes spanning between the extrusion surface and the back surface, and
an elastic polymer component at least partially filling at least some of the plurality of holes of the support film and forming a first layer thereon; and
attaching a second layer to the first layer of the first assembly.

22. The method of claim 21, wherein the holes extend fully between the extrusion surface and the back surface creating a plurality of through holes.

23. The method of claim 22, wherein the through holes are created by flame treating the back surface of the support film.
